(19) United States
(12) Patent Application Publication
(10) Pub. No.: US 2003/0163406 A1
(43) Pub. Date: Aug. 28, 2003

(54) Blind bidding negotiation support system for any number of issues

(76) Inventors: Ernest Marvin Thiessen, Abbotsford (CA); Ian Thomas Upright, Vancouver (CA)

Correspondence Address: William A. Blake, Jones, Tullar & Cooper, P.C., P.O. Box 2266 Eads Station, Arlington, VA, 22202, US

(21) Appl. No.: 10/022,797

(22) Filed: Dec. 20, 2001

Related U.S. Application Data
(60) Provisional application No. 60/256,935, filed on Dec. 21, 2000.

(51) Int. Cl. G06F 17/60

(52) U.S. Cl. 705/37

(57) ABSTRACT

A computer-based blind-bidding system for supporting negotiations with any number of issues and any number of parties is disclosed. After negotiation issues are created, each negotiating party defines preferred outcomes and associated relative importances for each issue. Confidential information is managed by a neutral site where parties have access only to their only private information and that which other parties share with them. Parties can then create proposals and other potential agreements within those ranges, which may be visible to other parties or not, at their own option. Upon request, the system generates visible suggestions, which are potential agreements whose values are derived from party preference information. If some suggestions already exist, new suggestions fall between existing suggestions. Parties can see the suggestions generated by the system, but are “blind” to a confidential acceptance that any other party may indicate with respect to any package. Two or more parties reach an agreement when they accept the same potential agreement.

### CROSS REFERENCE TO RELATED APPLICATIONS

This application claims priority under 35 USC 119(e) on U.S. Provisional Patent Application No. 60/256,935 filed Dec. 21, 2000.

### BACKGROUND OF THE INVENTION

1. Field of the Invention

The present invention relates in general to a computer-based decision support system for multiple parties involved in any type of negotiation. In complex negotiations, the system assists parties in reaching an agreement that optimizes the individual and overall benefit to the parties.

2. Description of the Background Art

Negotiation is a process where two or more parties with conflicting objectives attempt to reach an agreement. This process includes not only bargaining—the presentation and exchange of proposals for addressing particular issues—but also the attempts by each party to discover and use knowledge of the preferences, strengths and weaknesses of their opponents to reach a resolution that maximizes their own objectives while still being acceptable to other parties. Negotiating parties may be individuals or teams representing their own interests or the interests of their organizations. When there is at least some willingness to engage in negotiation, it can be a constructive alternative to other means (e.g., violence, litigation, stalemate) of settling disputes.

Negotiators have several basic tasks, which are non-trivial when many issues are involved:

| | |
|---|---|
| Qualify Interests | Identify potential agreements that will be |
| | acceptable to all parties. |
| Quantify Satisfaction | Determine how each party would become |
| | satisfied on each of the issues. |
| Establish Equity | Agree on how the benefits should be divided |
| | among the parties. |
| Maximize Benefits | Find an outcome that maximizes the mutual |
| | benefits for the parties. |
| Secure Commitment | Insure that the agreement will be implemented |
| | as expected. |

In order to accomplish these tasks, negotiators must explore the impacts of various decisions, and at least begin to understand the tradeoffs among these impacts. A third party mediator or facilitator may be included in a negotiation process to help manage the interactions and make suggestions for negotiating parties to consider. Alternatively, an arbitrator may be involved with the power to draft and perhaps dictate settlements for the parties. It is commonly recognized that such disinterested parties can significantly help negotiators in their quest for an agreement.

Recent developments in modeling negotiation processes, more powerful computers, and the maturing of the Internet are motivating work in the use of computer-based analyses and network solutions for complex negotiation problems. State-of-the-art interactive interfaces today permit the updating of issues, preferences, and interested stakeholders as the negotiation process proceeds.

The current literature on interactive computer programs for multi-objective conflict resolution commonly uses the term Negotiation Support System. This term refers to the special type of group decision support system designed for providing assistance in situations where there is disagreement and conflict among various parties as to what decisions to adopt. Research addressing group decision making in multi-objective situations is in its third decade, yet the development and use of Negotiation Support Systems to facilitate and help guide multi-party negotiations is still considered a relatively new field.

Negotiation Support Systems can be categorized according to their functions either as negotiation preparation systems, supporting a pre-negotiation strategic planning stage, or negotiation information management systems, facilitating negotiations in real time. Negotiation information management systems can be further classified as either context support systems or process support systems. Context models focus on the behavior of the system being designed, managed or operated. Such models are used to answer questions about the performance of the system given any particular decision regarding its design, management or operation. Process models are concerned with the dynamics or procedure of the negotiation process that includes how a group of parties with differing and conflicting objectives can reach an acceptable agreement.

Numerous efforts are underway in each of the various kinds of Negotiation Support Systems described above. Of particular interest here are process support systems. These systems are designed to provide a practical means of increasing the likelihood of mutually agreeable settlements when a potential region of agreement exists. Sometimes they can help identify better solutions than would have been found without their use. The majority of process support systems described in the literature for complex negotiations, are still in the conceptual stage, or, at best, play a relatively passive role in the negotiation process. There are some working systems that are single workstations that support a professional mediator rather than the negotiating parties directly. The one prior art process support system that stands out in its ability to substantially aid negotiating parties in a complex real-world setting is ICANS, as described in U.S. Pat. No. 5,495,412 and presently implemented in SmartSettle (www.SmartSettle.com).

There are also some other very simple existing systems for automated single-issue blind bidding (CyberSettle (www.cybersettle.com), ClickNsettle (www.cybersettle.com) and a number of others (http://www.ombuds.org/center/aaron/adronline2001/01/january_op-ed.htm). The other blind bidding systems all have one thing in common, in that they take proposals from each party and split the difference according to some agreed formula when proposals are close enough. These systems seem to have at least two drawbacks:

Parties must understand what formula is used for splitting the difference and make an extra calculation of what they might actually be agreeing to before making a proposal.

These systems are apparently not scalable to more than one issue.

A general problem in negotiations involving multiple issues is finding an optimal agreement in light of complexity and different confidential preferences of the negotiating parties.

### BRIEF SUMMARY OF THE INVENTION

A computer-based interactive blind-bidding system for supporting negotiations is disclosed. The method described here improves upon that described as ICANS in U.S. Pat No. 5,495,412. In this system, issues are created with each negotiating party indicating preferred outcomes for each issue. Parties can then create proposals and other potential agreements within those ranges, which may be visible to other parties or not, at their own option. When requested by the parties, the system generates visible potential agreements whose values are derived on the basis of preference information provided by the parties. If some potential agreements already exist, newly generated potential agreements fall between the existing ones in terms of satisfaction levels. In this system, parties can see the potential agreements suggested by the system, but are “blind” to a confidential acceptance that any other party can indicate with respect to any package. Two or more parties reach an agreement when they accept the same potential agreement.

In general, the disclosed system assists any number of parties involved in simple or complex negotiations with any number of issues in reaching an agreement that optimizes both the individual and overall benefit to the parties. The parties begin by collaborating in building a Framework for Agreement. The Framework for Agreement may include constraints that relate two or more issues. From the Framework for Agreement, a list of issues can be derived and entered into a computer system. Each of the parties to a conflict or dispute to be negotiated then enters their own preferences concerning each issue of the conflict into the computer system. They may also enter private issues and/or private constraints if this provides a better problem description.

If desired, each party to the dispute can have a separate computer system so that each party's preference information remains confidential to that party. The preference information includes data on satisfaction functions for each of the issues. Each satisfaction function defines a party's relative level of satisfaction as a function of a numerical value for the outcome of that issue. The preference information for each party includes more preferred and less preferred outcomes that define bargaining ranges and a relative importance assigned to each issue with respect to its bargaining range. With bargaining ranges defined, packages (sets of issue values) can be identified, each such package being a potential agreement. Every package that is created by any party or by the system is associated with a specified level of satisfaction or rating for each party that is determined by the issue satisfaction functions and relative importances. Each party has a private view in which packages are rated according to their own preferences.

Parties may create any number of private packages of issue values for their own consideration. The system may also generate one or more packages as potential agreements that, in terms of satisfaction levels, fall within bargaining ranges by the parties. In the remainder of this description and in the included illustrations, this type of package is referred to as a Suggestion. To assist a party in evaluating their own preferences, the system may generate one or more packages that are equivalent to other packages, i.e., provide approximately the same level of satisfaction to a party as other packages. Each party may also enter one or more packages of issue values that are published as proposed agreements (i.e. for other parties to see). If two or more parties have made proposals or have accepted packages that are close enough to each other (in terms of satisfaction levels), the system may generate another single package that simultaneously satisfies all parties by providing approximately the same level of satisfaction as their current proposals would provide. Parties may accept, in confidence, any package, including any Suggestion generated by the system that is displayed on their private view. If two or more parties accept the same package, that package becomes a tentative agreement among those parties.

Packages that are generated by the system are done so using optimization techniques, the preferred method using standard mixed-integer linear programming techniques to solve an appropriate optimization problem that takes into account the preference information of the parties and obeys any shared or private constraints that have been defined. “Minimizing the maximum gain” between existing proposals and a generated package is one technique that may be used to generate an equivalent package for two or more parties. Once parties have reached a tentative agreement by any means, parties may elect to have an optimal agreement to the conflict determined, again using linear programming techniques, by “Maximizing the minimum gain” in satisfaction achieved by each of the parties in going from the tentative to an improved package of issue values. This will, at the same time, maximize the overall benefit to all of the parties. For maximum security of all party's confidential information, a separate computer system located at a neutral site can be connected to each individual party's computer system. In this case, packages are generated at the neutral site and transmitted back to each party's own computer system. Encryption is used to maintain transmission security. This entire system may be automated in repetitive negotiations in which the computer systems controlled by the parties may derive required input information from simulation models rather than that information having to be explicitly entered each time.

The main advantage of the disclosed system over previous systems is that it allows decision makers to use blind bidding (where acceptances are blind) to quickly reach an agreement in a negotiation involving any number of issues. It is also superior to other methods of blind bidding, even with single issues, because it does not require any “split-the-difference” formula. By its very nature, multi-issue blind bidding based on the preferences of the negotiators tends to produce agreements that are closer to optimal than other methods.

### BRIEF DESCRIPTION OF THE DRAWINGS

The figures in the following list appear as drawings referred to in the detailed description and in the illustration appended to the detailed description. The illustration is a hypothetical negotiation between two parties named BigCo and Sally. Several scenarios are presented in order to illustrate the most preferred embodiments of the method and assist the reader to completely understand the invention. Scenario IA illustrates a more conventional method of negotiation, in which parties consider visible proposals. The result is optimized in a post-settlement analysis (Scenario IB) (as described in ICANS patent). Scenarios II and III illustrate how multi-issue blind bidding is implemented with SmartSettle. In Scenario II parties both accept the same Suggestion. This becomes a tentative agreement and the result is subsequently optimized to find improvements. In Scenario III, the Equivalent Suggestion is first used to solve an invisible impasse that parties have reached in the blind bidding process. Each Figure is associated with a code that refers to the party view, scenario, and the figure sequence number within that scenario. For example, SS1 means “Sally Start 1”, SIA1 means “Sally Scenario IA 1”, and SM1 means “Sally Middle 1”.

### Introduction

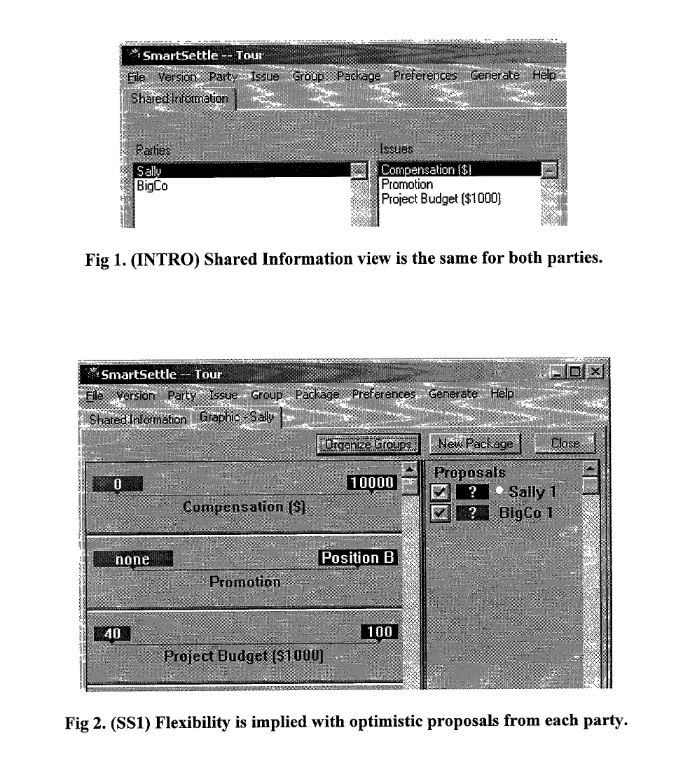

FIG. 1. (INTRO) Shared Information view is the same for both parties.

### Sally's Viewpoint

FIG. 2. (SS1) Flexibility is implied with optimistic proposals from each party.

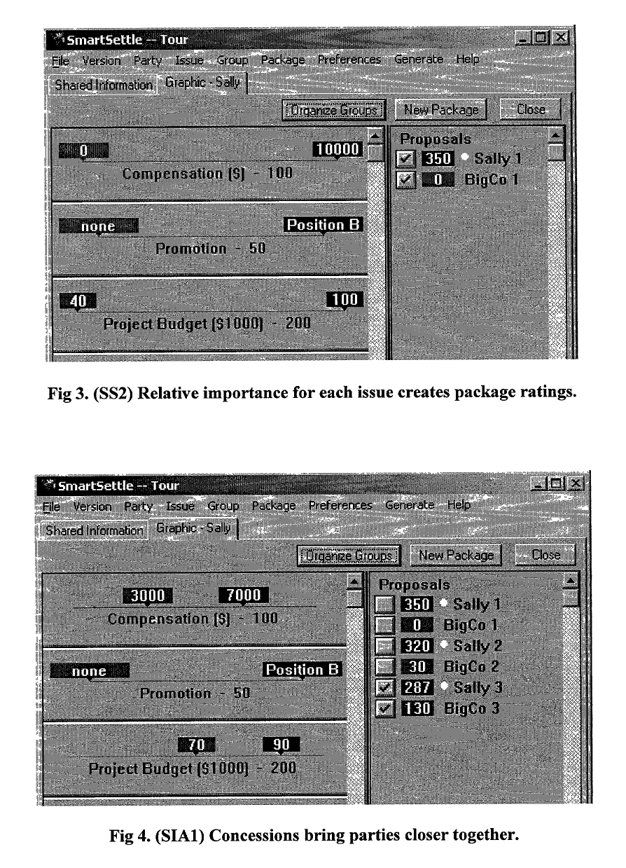

FIG. 3. (SS2) Relative importance for each issue creates package ratings.

FIG. 4. (SIA1) Concessions bring parties closer together.

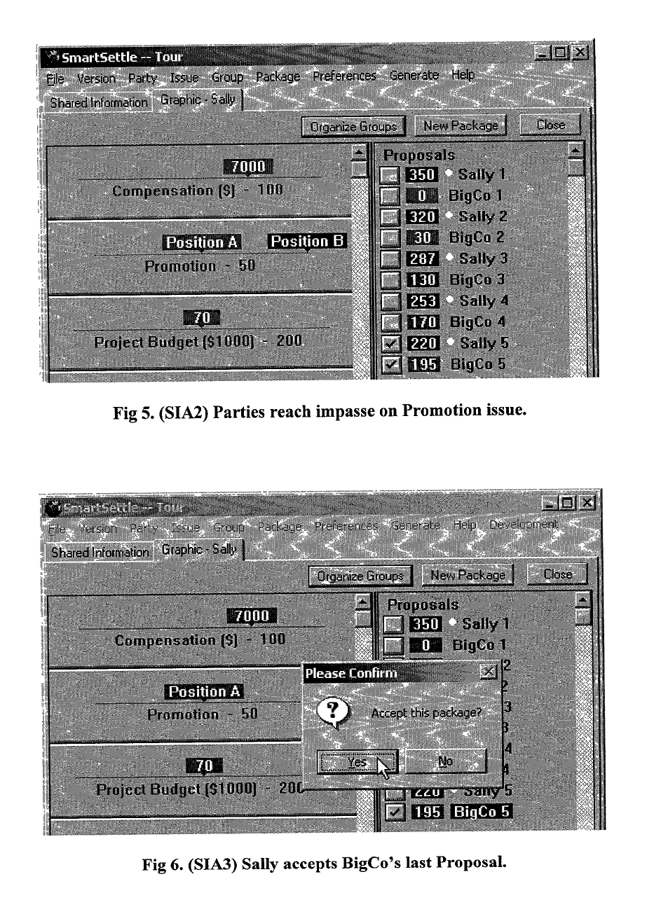

FIG. 5. (SIA2) Parties reach impasse on Promotion issue.

FIG. 6. (SIA3) Sally accepts BigCo's last Proposal.

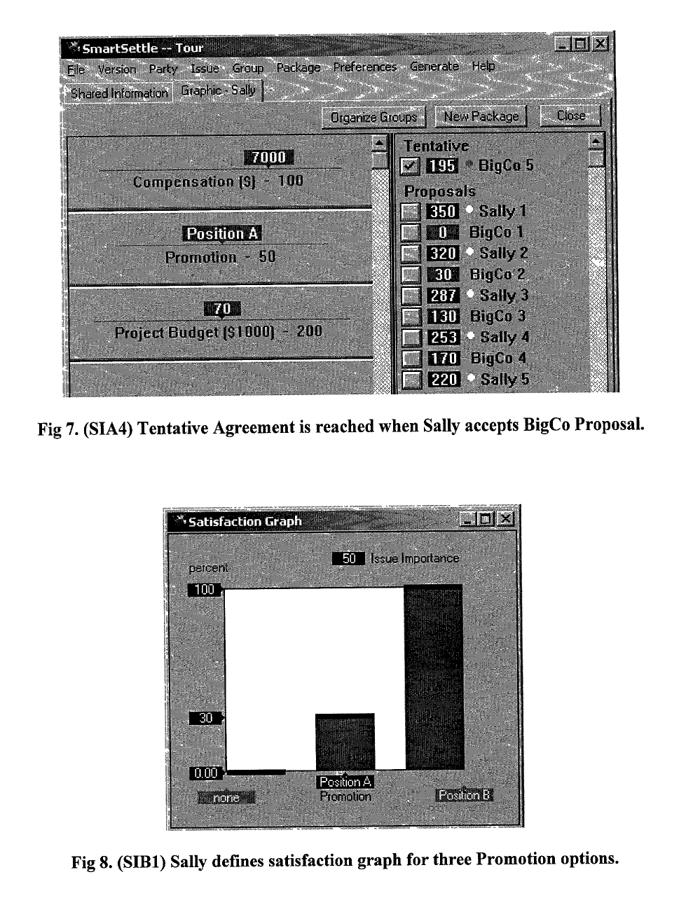

FIG. 7. (SIA4) Tentative agreement is reached when Sally accepts BigCo Proposal.

FIG. 8. (SIB1) Sally defines satisfaction graph for three Promotion options.

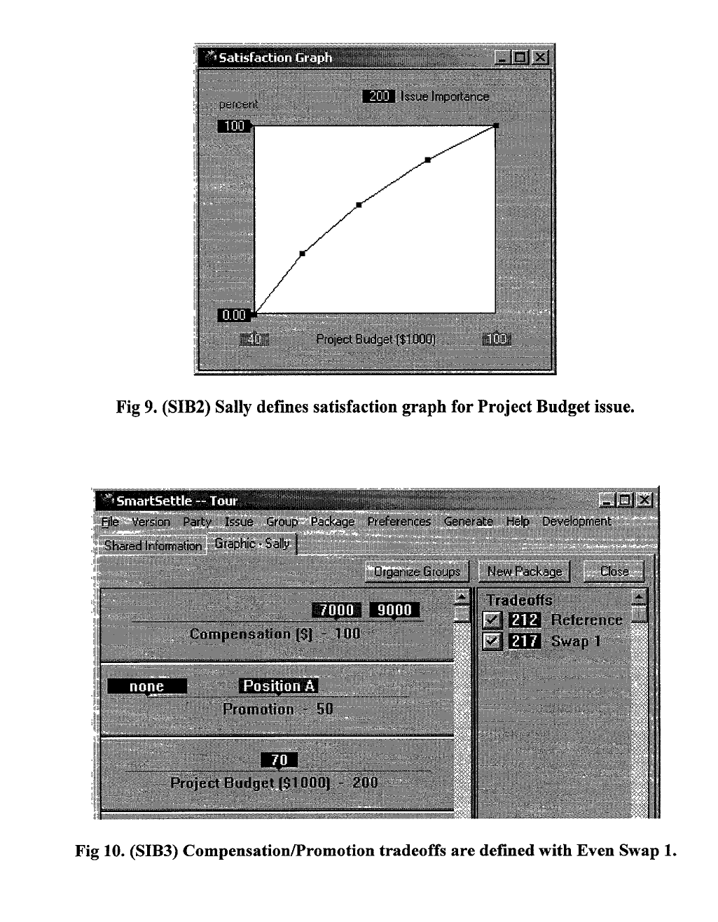

FIG. 9. (SIB2) Sally defines satisfaction graph for Project Budget issue.

FIG. 10. (SIB3) Compensation/Promotion tradeoffs are defined with Even Swap 1.

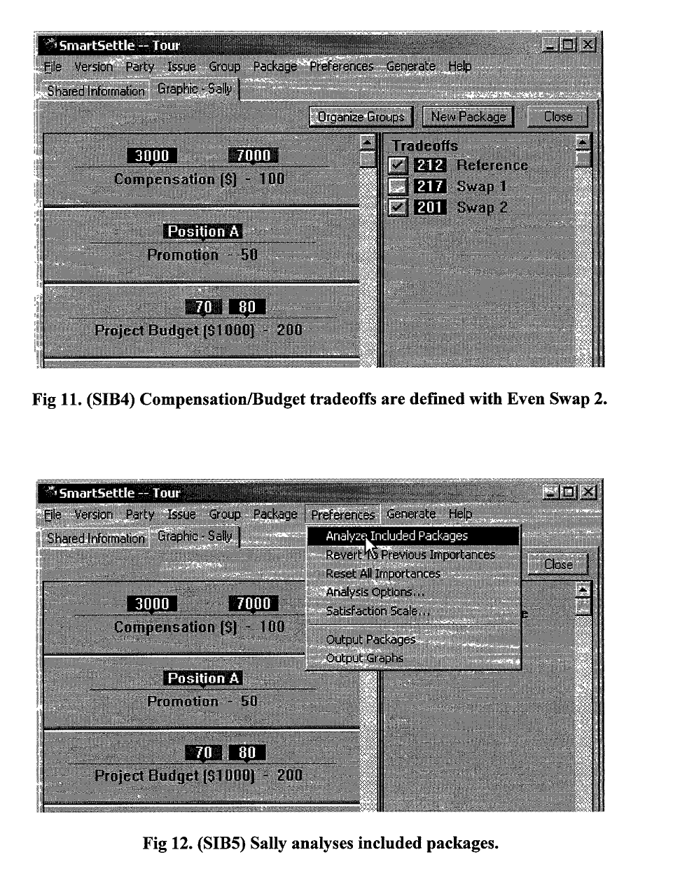

FIG. 11. (SIB4) Compensation/Budget tradeoffs are defined with Even Swap 2.

FIG. 12. (SIB5) Sally analyses included packages.

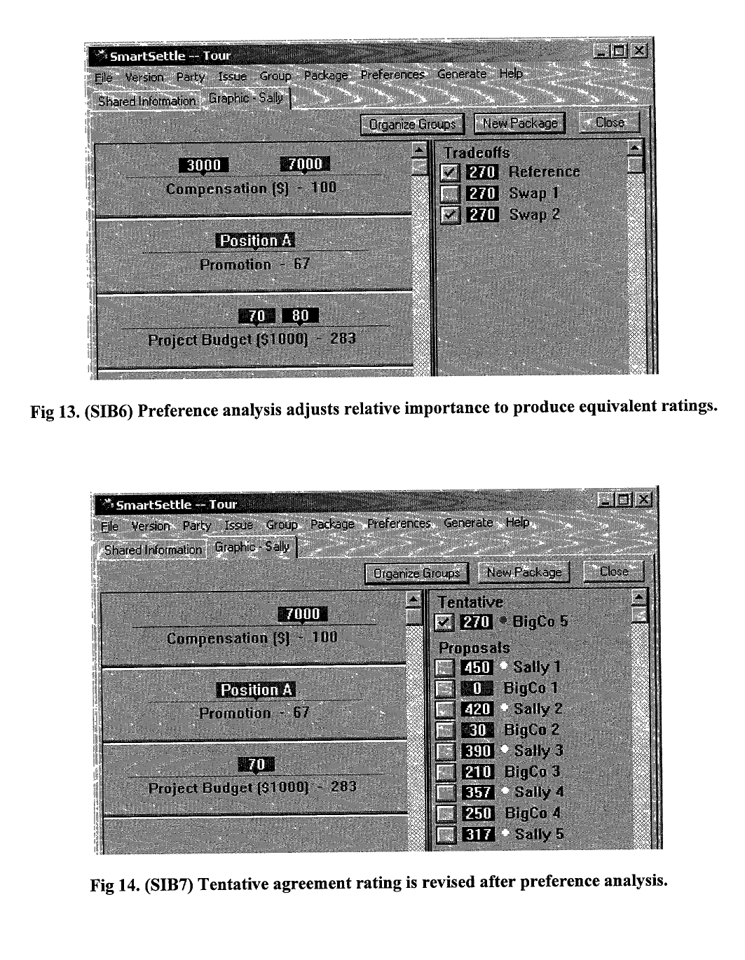

FIG. 13. (SIB6) Preference analysis adjusts relative importance to produce equivalent ratings.

FIG. 14. (SIB7) Tentative agreement rating is revised after preference analysis.

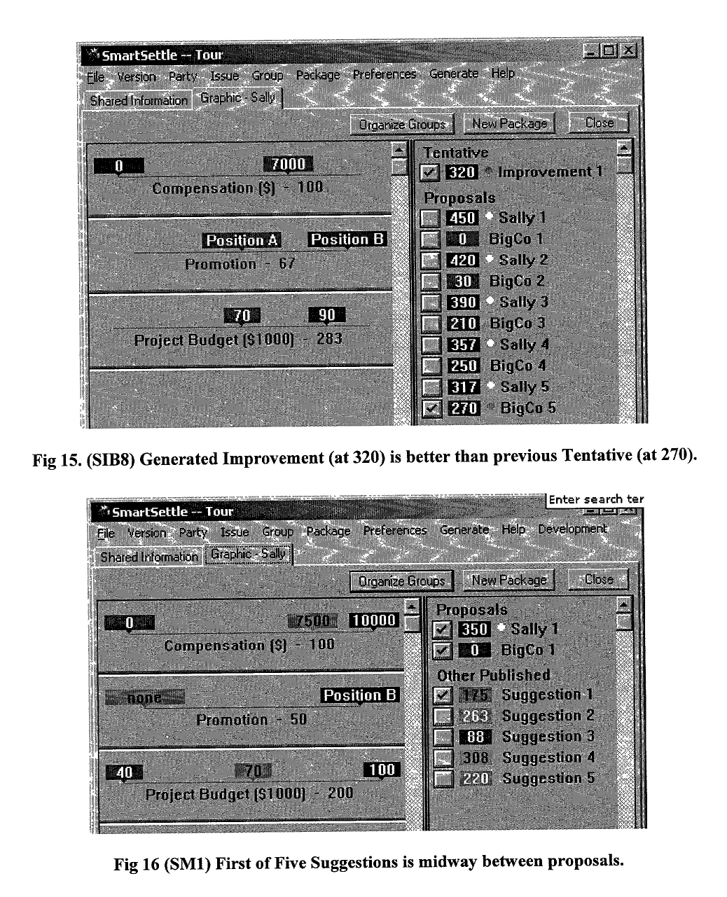

FIG. 15. (SIB8) Generated Improvement (at 320) is better than previous Tentative (at 270).

FIG. 16. (SM1) First of five Suggestions is midway between proposals.

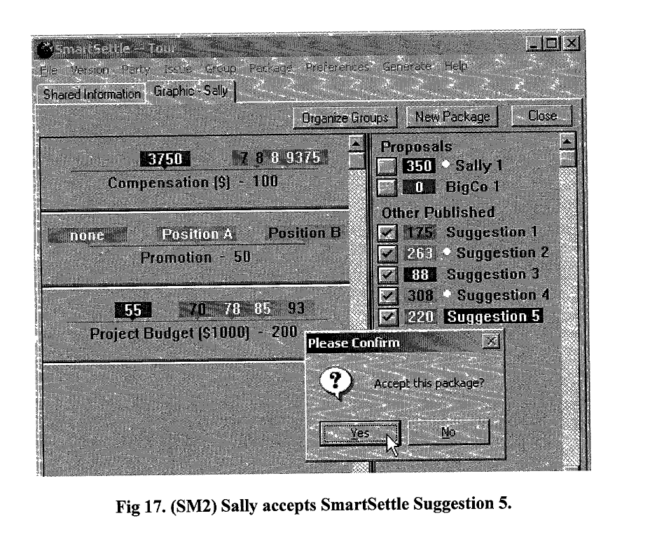

FIG. 17. (SM2) Sally accepts SmartSettle Suggestion 5.

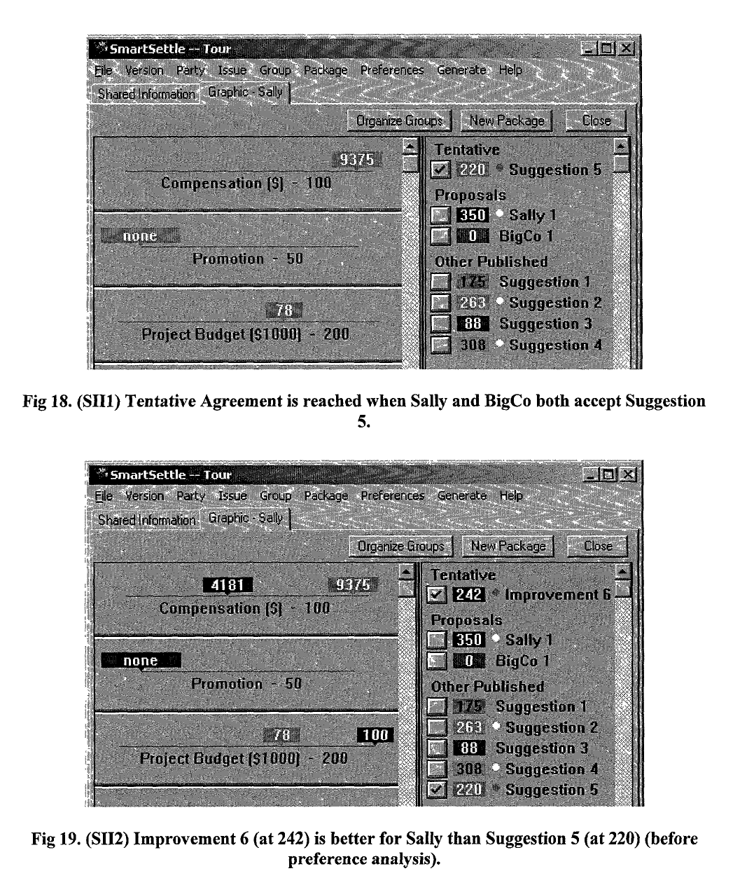

FIG. 18. (SII1) Tentative agreement is reached when Sally and BigCo both accept Suggestion 5.

FIG. 19. (SII2) Improvement 6 (at 242) is better for Sally than Suggestion 5 (at 220) (before preference analysis).

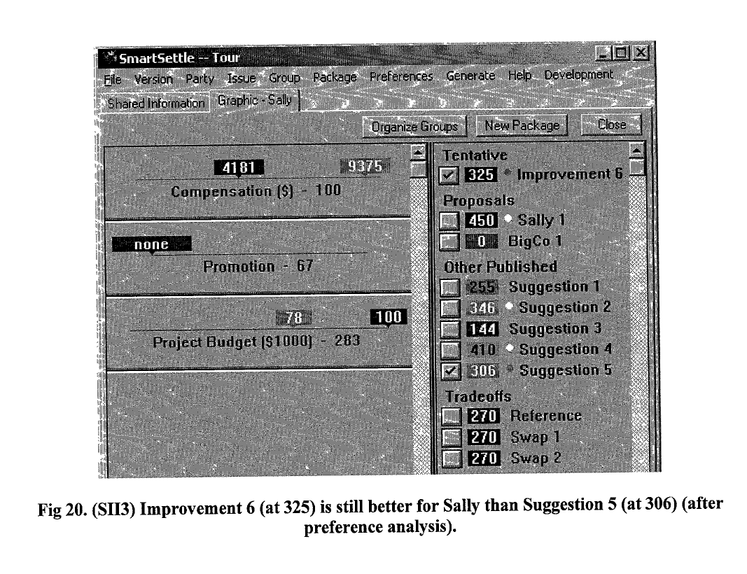

FIG. 20. (SII3) Improvement 6 (at 325) is still better for Sally than Suggestion 5 (at 306) (after preference analysis).

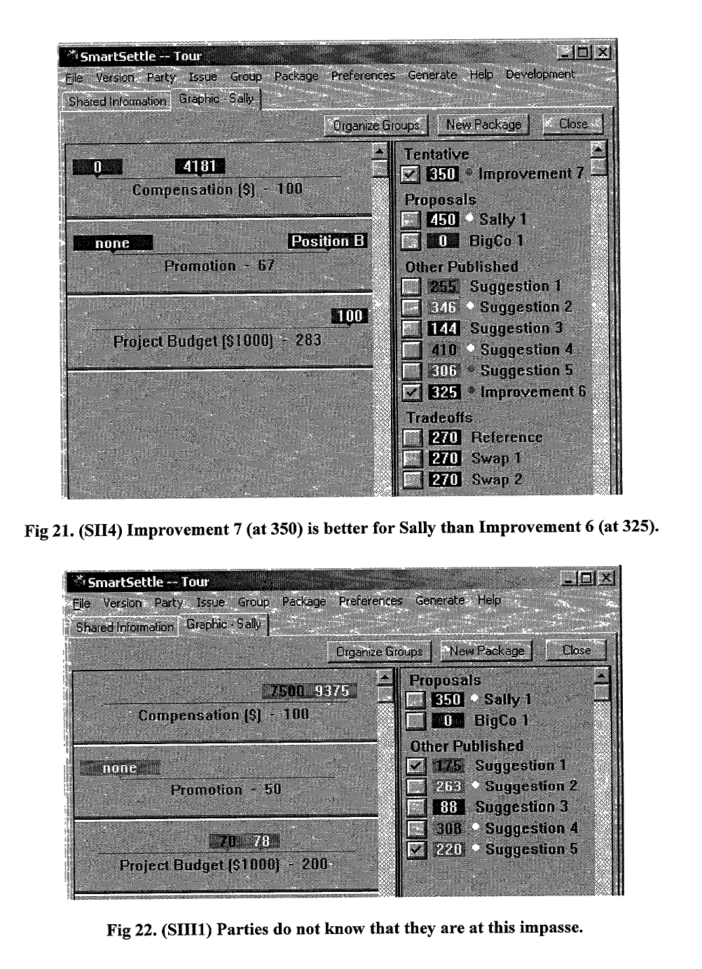

FIG. 21. (SII4) Improvement 7 (at 350) is better for Sally than Improvement 6 (at 325).

FIG. 22. (SIII1) Parties do not know that they are at this impasse.

FIG. 23. (SIII2) Generated Equivalent 6 satisfies both parties (at 220 for Sally).

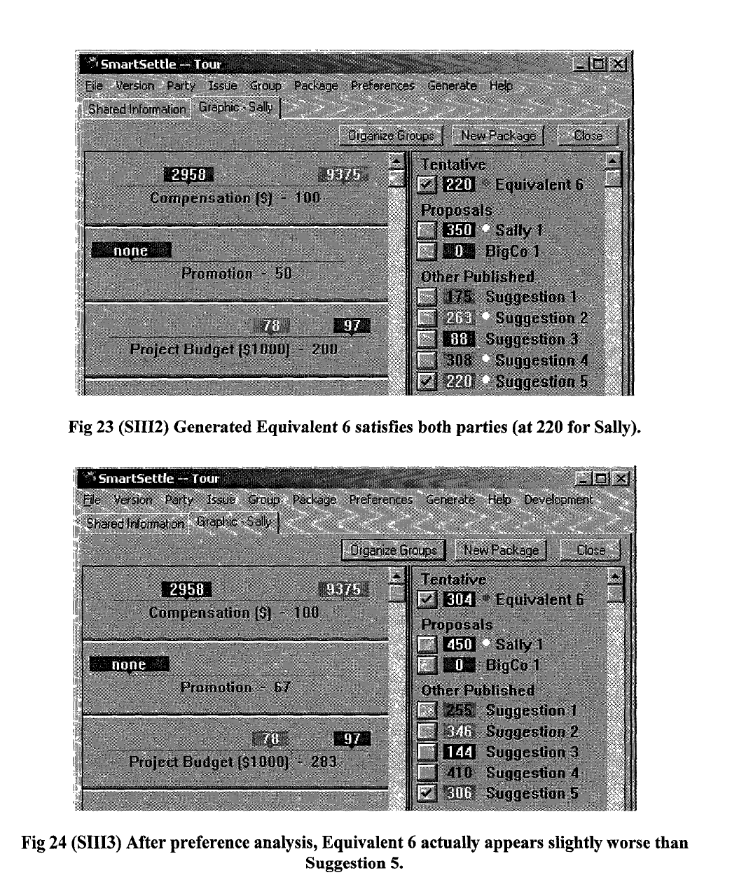

FIG. 24. (SIII3) After preference analysis, Equivalent 6 actually appears slightly worse than Suggestion 5.

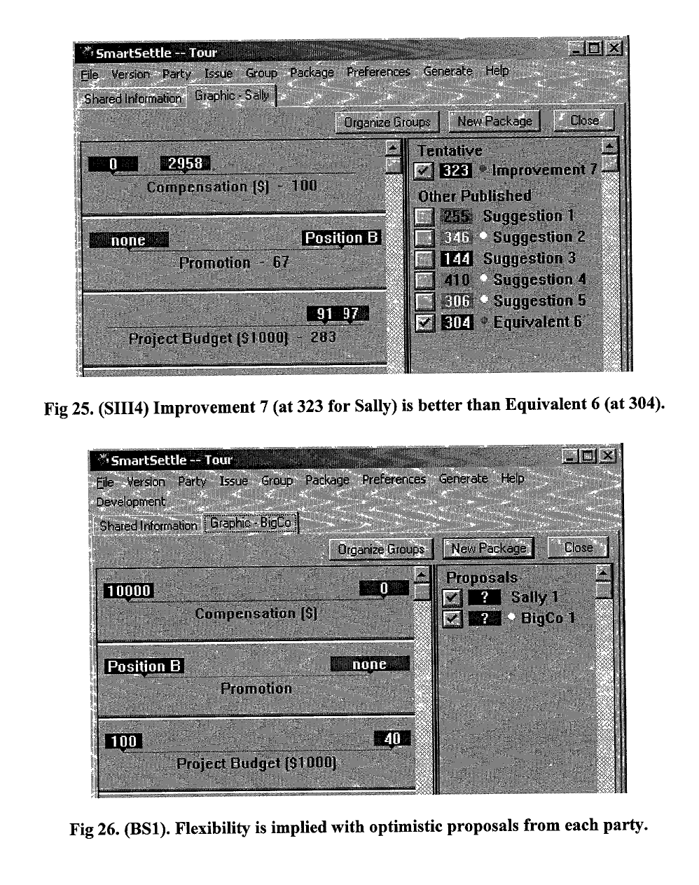

FIG. 25. (SIII4) Improvement 7 (at 323 for Sally) is better than Equivalent 6 (at 304).

### BigCo's Viewpoint

FIG. 26. (BS1) Flexibility is implied with optimistic proposals from each party.

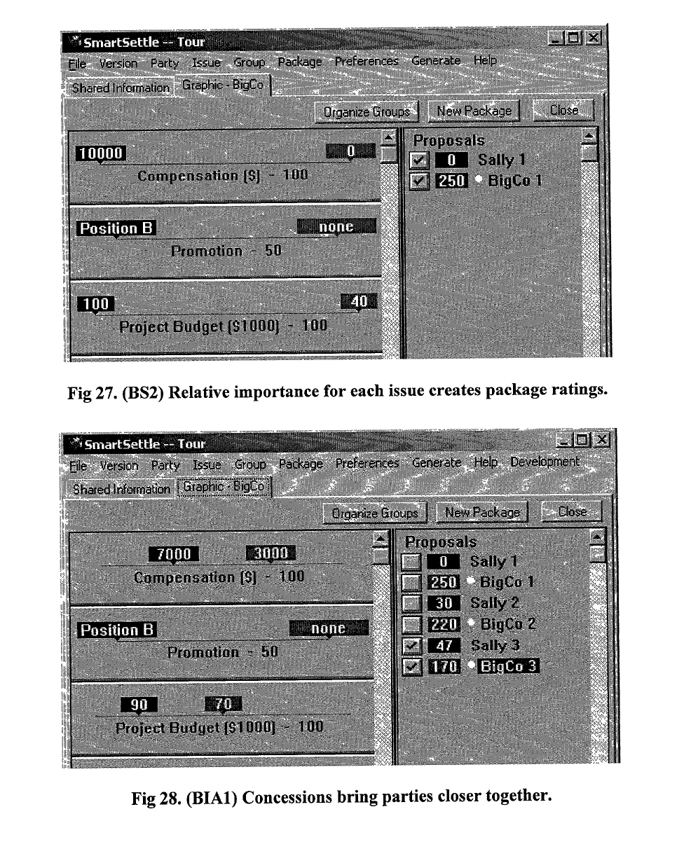

FIG. 27. (BS2) Relative importance for each issue creates package ratings.

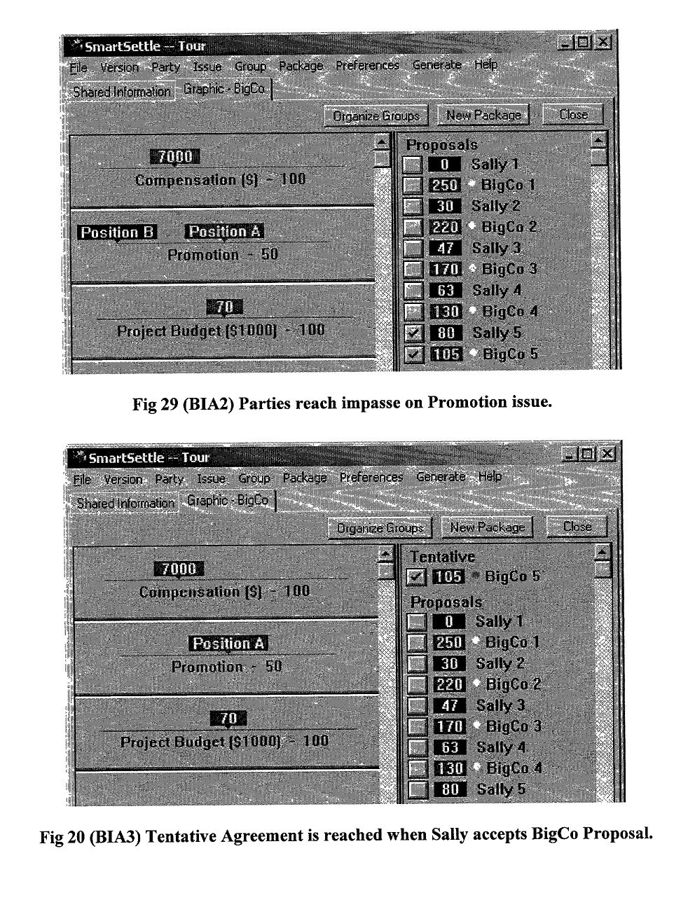

FIG. 28. (BIA1) Concessions bring parties closer together.

FIG. 29. (BIA2) Parties reach impasse on Promotion issue.

FIG. 30. (BIA3) Tentative Agreement is reached when Sally accepts BigCo proposal.

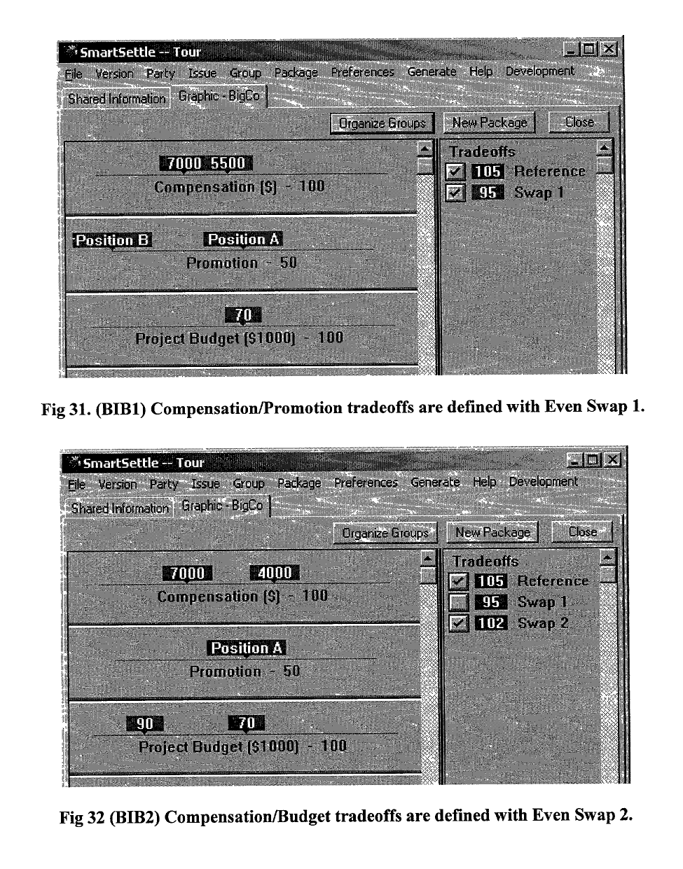

FIG. 31. (BIB1) Compensation/Promotion tradeoffs are defined with Even Swap 1.

FIG. 32. (BIB2) Compensation/Budget tradeoffs are defined with Even Swap 2.

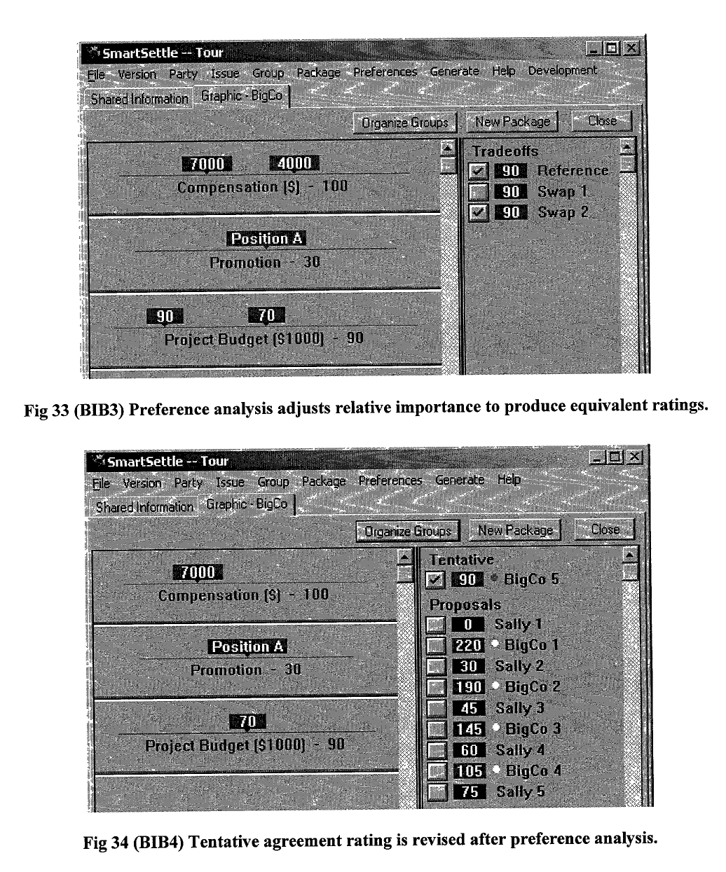

FIG. 33. (BIB3) Preference analysis adjusts relative importance to produce equivalent ratings.

FIG. 34. (BIB4) Tentative agreement rating is revised after preference analysis.

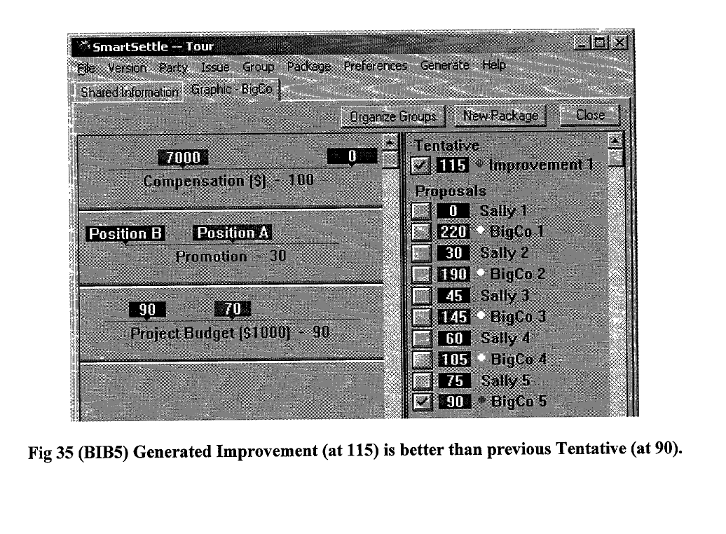

FIG. 35. (BIB5) Generated Improvement (at 115) is better than previous Tentative (at 90).

FIG. 36. (BM1) BigCo accepts SmartSettle Suggestion 3.

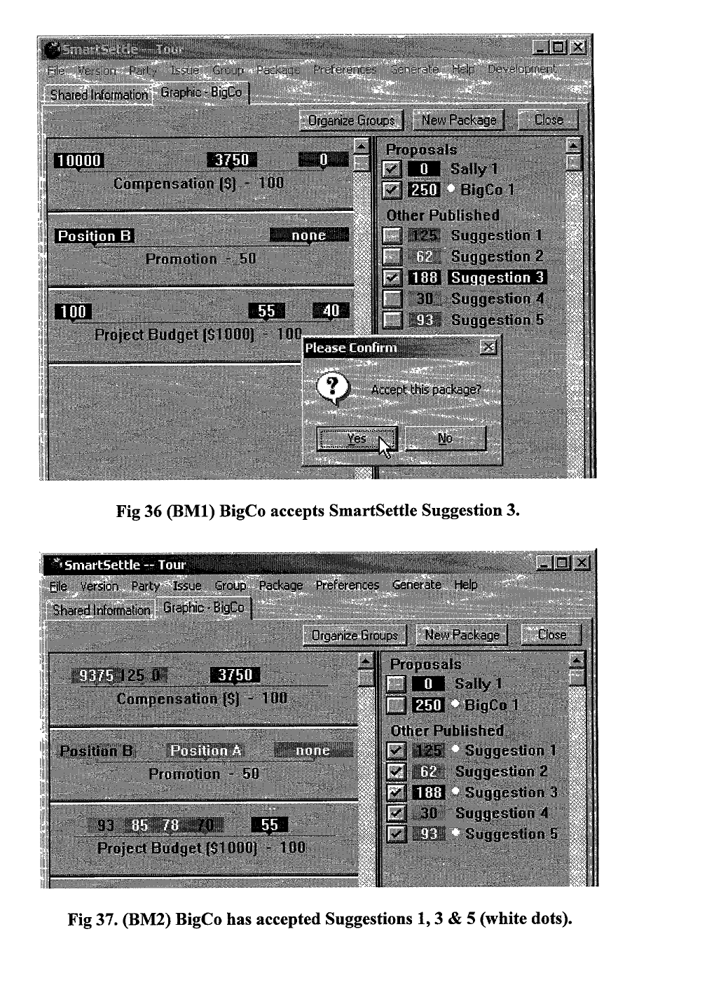

FIG. 37. (BM2) BigCo has accepted Suggestions 1, 3 & 5 (white dots).

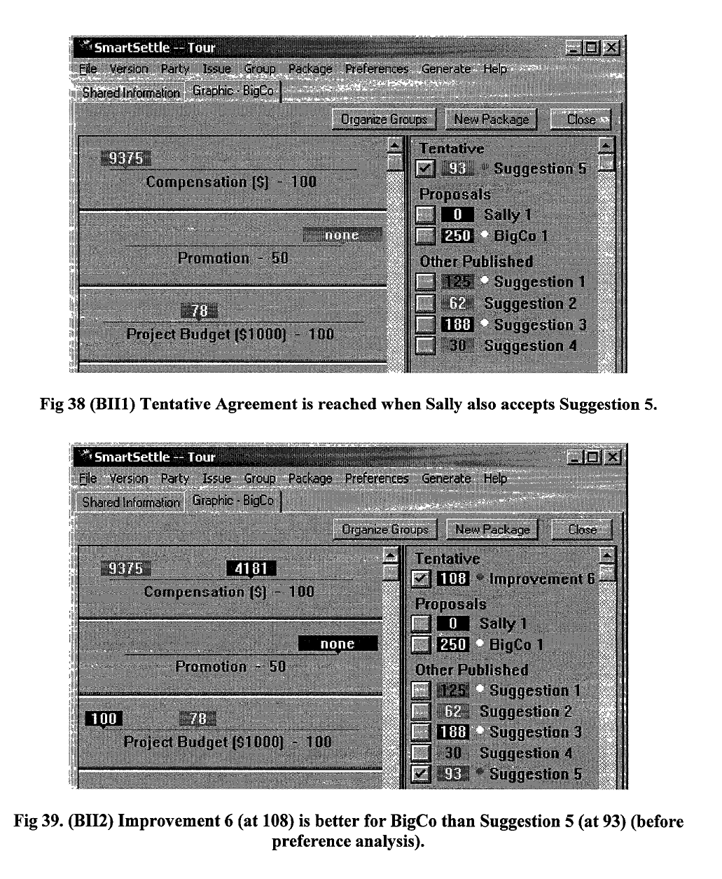

FIG. 38. (BII1) Tentative agreement is reached when Sally also accepts Suggestion 5.

FIG. 39. (BII2) Improvement 6 (at 108) is better for BigCo than Suggestion 5 (at 93) (before preference analysis).

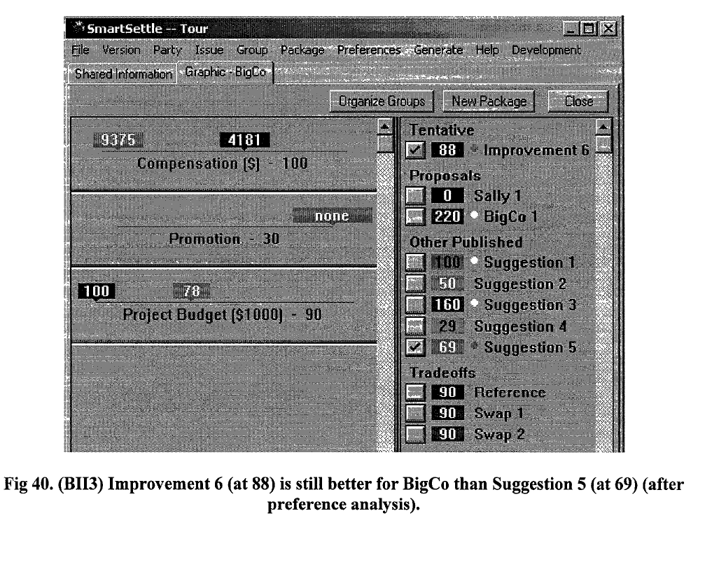

FIG. 40. (BII3) Improvement 6 (at 88) is still better for BigCo than Suggestion 5 (at 69) (after preference analysis).

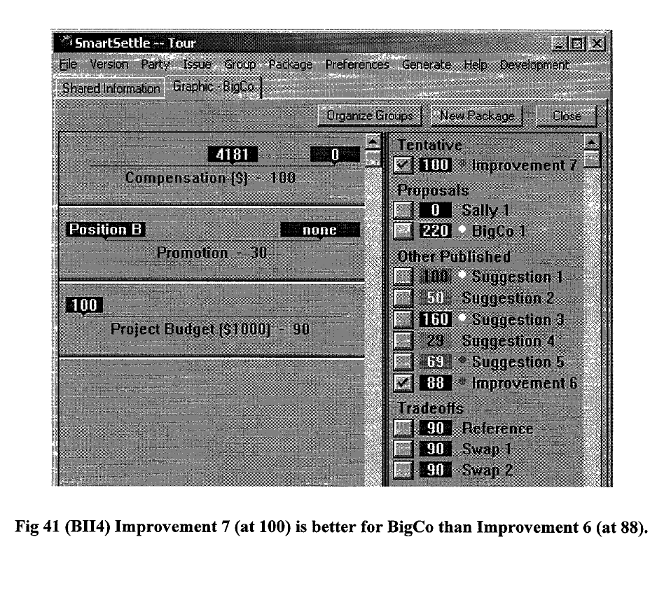

FIG. 41. (BII4) Improvement 7 (at 100) is better for BigCo than Improvement 6 (at 88).

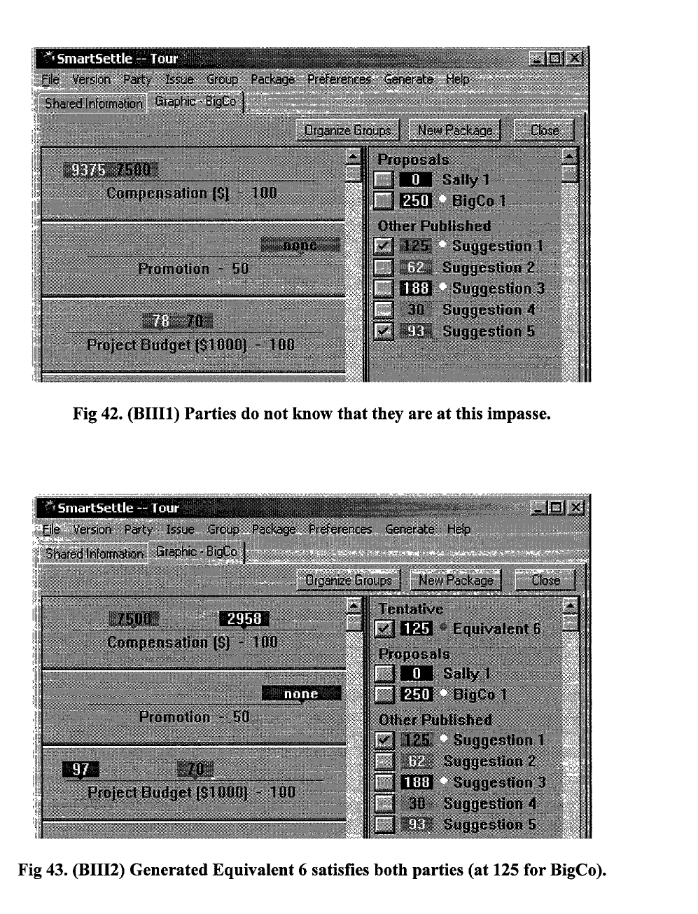

FIG. 42. (BIII1) Parties do not know that they are at this impasse.

FIG. 43. (BIII2) Generated Equivalent 6 satisfies both parties (at 125 for BigCo).

FIG. 44. (BIII3) After preference analysis, Equivalent 6 appears better than Suggestion 1.

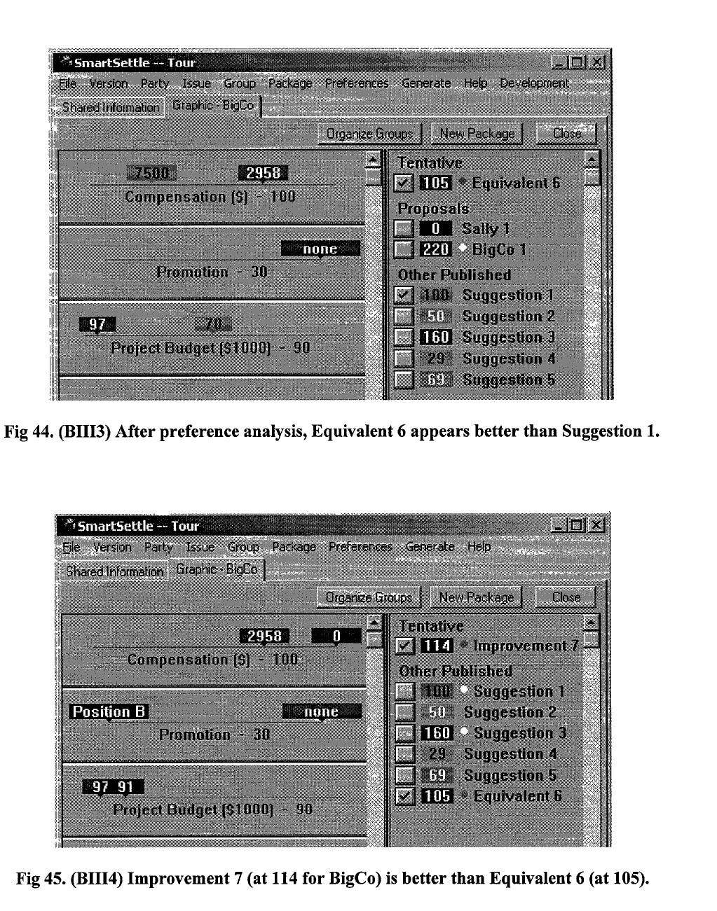

FIG. 45. (BIII4) Improvement 7 (at 114 for BigCo) is better than Equivalent 6 (at 105).

### DETAILED DESCRIPTION OF THE INVENTION

### Overview

The present invention improves one aspect of the previously described ICANS (U.S. Pat. No. 5,495,412) negotiation process support system with a new method called multi-issue blind bidding. The multi-issue blind bidding method is described here in the wider context of the original ICANS method (Scenarios IA and IB) in order to illustrate the most preferred embodiment of the method and assist the reader to completely understand the invention. The disclosed system has recently been implemented by a release of SmartSettle at www.smartsettle.com and will be referred to by that name throughout this description.

In general, SmartSettle is implemented on a computer by providing the negotiating parties with an acceptable interactive graphical interface. It assists any number of parties involved in simple or complex negotiations with any number of issues in reaching an agreement that quickly produces an optimal agreement, maximizing the joint benefits of all parties. If desired, each party to the dispute can have a separate computer system in a network with a neutral site so that each party's preference information remains confidential to that party.

As with ICANS, SmartSettle requires parties to first collaborate in building a Framework for Agreement. The Framework for Agreement may include constraints that relate two or more issues. From the Framework for Agreement, a list of issues can be derived and entered into a computer system. The system then needs to elicit at least a minimum amount of preference information from each party for the purpose of creating mathematical representations of preferred outcomes, bargaining ranges and satisfaction ratings for potential agreements. Parties may also enter private issues and/or private constraints if this provides a better problem description. With preferences well represented, SmartSettle is able to generate Suggestions and other packages on which parties can place a confidential acceptance. When two parties accept the same package an agreement is declared.

### Preferences Required for Package Evaluation

Before parties can enter information regarding their preferences on the outcome of a particular issue, a range of acceptable outcomes for that issue from less desirable to more desirable must be defined. This range is referred to here as a bargaining range. Within this range, SmartSettle, by default, generates a linear relative satisfaction function to define that party's relative level of satisfaction as a function of a numerical value for the outcome of that issue. However, the party has the option of changing that function to more accurately describe their relative satisfaction function by picking points on the graphical interface (FIG. 8, FIG. 9).

With bargaining ranges defined, packages (sets of potential decision values for each unresolved issue) can be identified, each such package being a potential agreement. Every package that is created by any party or by the system is associated with a specified level of satisfaction or rating for each party that is determined by the issue satisfaction functions and relative importances. Each party has a private view in which packages can be evaluated according to their own preferences.

### Preference Elicitation and Analysis Methods

SmartSettle provides four distinct ways for each party to define the satisfaction tradeoffs between issues that determine the relative importance of each issue with respect to its bargaining range. Two of these ways involve comparisons of additional satisfaction associated with bargaining ranges. The additional satisfaction associated with bargaining ranges can either be defined as being equivalent or can be rated relative to each other. The other two ways involve comparisons of the satisfaction levels of two or more packages. In this case, packages can either be defined as being equivalent to one another (FIG. 10, FIG. 11, FIG. 31, FIG. 32), or can be rated relative to each other. SmartSettle analyzes this information to assist parties in forming a more accurate preference representation (Scenario IB, FIG. 19, FIG. 20, FIG. 39, FIG. 40, FIG. 24, FIG. 44).

Types of Packages

SmartSettle uses the ranges, satisfaction functions and satisfaction tradeoff information to generate a rating that represents the relative total satisfaction value that each package will provide the party. Once SmartSettle has sufficient information with which to rate packages, parties can create packages that may be private or published for other negotiators to see. Published packages may be declared as proposals or for discussion purposes. Parties may also select from a menu, any one of several different types of packages for SmartSettle to generate; Split, Suggestion, Equivalent, Improvement, or Dominant. Except for Equivalent, each of these functions always simultaneously generate an identical package for all parties, defined as follows:

Split: a generated package that provides each party as close as possible to, but not less than, the average of the satisfaction ratings of existing party proposals.

Suggestion: a generated package that falls between other existing packages (proposals and other Suggestions) in terms of satisfaction ratings to each viewing party (FIG. 16).

Equivalent: a generated package that is equivalent, in terms of satisfaction ratings, to a party's least preferred acceptable package but different enough, in terms of issue values, to allow a party to check their preferences. If two or more parties have made proposals or have accepted packages that are close enough to each other (in terms of satisfaction levels), the system may generate an Equivalent that simultaneously satisfies all parties by providing approximately the same level of satisfaction as their current proposals would provide. With confidential acceptances, this functionality allows the system to solve visible or invisible impasses (FIG. 22, FIG. 42). Whether or not SmartSettle has generated different packages for all parties, or the same identical package for all of them, is not revealed to the parties unless it becomes an agreement through acceptance (FIG. 23, FIG. 43).

Improvement: a generated package that is better than the tentative agreement for at least one party and not worse for any others and falls on the efficiency frontier.

Dominant: a generated package that falls on the efficiency frontier. This outcome of this procedure is the same as if a Split had first been generated and then an Improvement.

### Multi-Issue Blind Bidding

While other systems take a series of proposals (bids) from parties and keep them hidden, the present invention takes published (visible) proposals (FIG. 2, FIG. 26) or bargaining ranges and responds with visible potential agreement packages (FIG. 16) that are generated as a function of user preferences as described above. Parties can see the packages that are generated by SmartSettle, but are “blind” to a confidential acceptance that any party can indicate with respect to any package (FIG. 17, FIG. 36, FIG. 37). When two or more parties accept the same package, an agreement is declared between those parties (FIG. 18, FIG. 38). This is what is defined as the multi-issue blind bidding method. When this method is applied to a single-issue negotiation, it has an advantage over other methods, in that parties can see exactly what they are agreeing to and do not need to understand any “split the difference” formula before making proposals.

Multi-issue blind bidding, as defined in this document, has a very desirable characteristic in that it tends to produce agreements that already fall close to the efficiency frontier, even without post-settlement optimization. The more Suggestions there are that are being considered, the better the result, in terms of being optimal.

### Optimization Methods

Whenever SmartSettle generates any type of package, it does so by solving an appropriate optimization problem. The preferred method is to use standard mixed-integer linear programming techniques to solve an appropriate optimization problem that takes into account the preference information of the parties and obeys any shared or private constraints that have been defined. Split and Equivalent both use an algorithm referred to as “Minimizing the Maximum Gain” between existing proposals and a generated package. Improvement and Dominant both use an algorithm referred to as “Maximizing the Minimum Gain”. In this method, once parties have reached a tentative agreement by any means, parties may elect to have an optimal agreement to the conflict determined by “maximizing the minimum gain” in satisfaction achieved by each of the parties in going from the tentative to an improved package of issue values (FIG. 25, FIG. 45). This will, at the same time, maximize the overall benefit to all of the parties. For further details regarding those algorithms, see the description for U.S. Pat. No. 5,495,412 (ICANS).

Multi-issue blind bidding is implemented in SmartSettle with a routine called Suggestion. The objective of the Suggestion model is to find a package that comes as close as possible to the center of the largest gap between existing packages, as defined by the average size for all parties.

Preferably, since each of the parties to the negotiations normally wish to have their preferences kept confidential from each of the other parties, a separate computer system and associated graphical interface are necessary for each of the parties so that they can enter their preference information separately and confidentially. The separate computer systems can be programmed to carry out all of the initial calculations including generation of the relative satisfaction functions for each issue and generation of the total satisfaction for each package. This information can then be transmitted to a central computer system at a neutral site which processes all of the preference data from each of the parties, uses this information to generate requested packages, and transmits the results back to each of the parties. Encryption is used to maintain transmission security. This entire system may be automated in repetitive negotiations in which the computer systems controlled by the parties may derive required input information from simulation models rather than that information having to be explicitly entered each time.

### Illustration

The illustration that follows refers to the figures in the drawings section. The illustration is a hypothetical simple two-party workplace negotiation between an employee named Sally and her employer, BigCo. Several scenarios are presented in order to illustrate the most preferred embodiments of the method and assist the reader to completely understand the invention. Scenario IA illustrates a more conventional method of negotiation, in which parties consider visible proposals and one accepts a proposal made by the other. In Scenario IB, parties use SmartSettle's advanced preference analysis and optimization features to search for improvements to the agreement reached in Scenario IA (as described in ICANS patent).

Scenarios II and III illustrate how multi-issue blind bidding is implemented with SmartSettle. In Scenario II, which starts the same way as Scenario I, parties both accept the same Suggestion. This becomes a tentative agreement and the result is subsequently optimized to find improvements. In Scenario III, an Equivalent package is generated to solve an invisible impasse that parties have reached in the blind bidding process.

The text of the illustration is written primarily from Sally's viewpoint, although the figures show screenshots from both party's point of view. The scenarios that follow are organized as follows:

Introduction

Start

Scenario IA (continued from Start)

Scenario IB (continued from Scenario IA)

Middle of Scenarios II & III (continued from Start)

Scenario II (continued from Middle)

Scenario III (continued from Middle)

Introduction

Case Description: Sally is not feeling very good about her job situation. She claims discrimination and is feeling criticism for inadequate performance but says that low project funding is the main problem. Sally now wants a Promotion as well as an increase in Project Budget for the next fiscal year. BigCo would rather just settle this with a small lump sum Compensation and have the case go away.

In the preparation phase, the parties and their facilitator(s) meet face-to-face, or on the Internet with SmartSettle's electronic brainstorming tools to share interests and build a Framework for Agreement. A Framework for Agreement is like a draft of the final agreement except with blanks representing unresolved issues. In real cases, the Framework for Agreement and corresponding list of issues usually evolve during the course of negotiations. In this simple illustration, the issue list will remain fixed as listed here.

Compensation Lump Sum ($)

Promotion (None, Position A, Position B)

Project Budget ($1000)

FIG. 1 shows how the SmartSettle Shared Information window appears after the information about parties and issues has been entered. This screen appears the same to both parties.

Each negotiator also has a private view, which is determined by their own preferences. Following is a comprehensive description of the negotiation process written from the viewpoint of Sally. For comparison, reference is also made to figures showing corresponding screen shots taken from BigCo's viewpoint.

Start (Same for All Scenarios)

The SmartSettle process encourages parties to begin with optimistic proposals and be prepared to be flexible. Bargaining ranges are established in this way. A bargaining range delineates possible outcomes for a particular issue. Unless explicitly constrained by the parties, it is always possible for the negotiation to move outside initially defined ranges on any particular issue. Shown in FIG. 2 are the first optimistic proposals from each party as seen from Sally's viewpoint (BigCo viewpoint in FIG. 26). Sally's least preferred outcome, which in this case is also BigCo's first proposal, is displayed on the left-hand side. Sally's most preferred outcome, her own optimistic proposal in this case, is displayed on the right-hand side. Packages are displayed in different colors in order to provide contrast for the viewer.

A package is any complete set of decisions that could become the final agreement. Technically, a package is really a Framework for Agreement with all the blanks filled in. In SmartSettle, a package is represented with a set of issue values. Packages typically encountered with SmartSettle include a proposal, a concession, a suggestion, a split, an equivalent, a tentative solution, an improvement, and the final agreement. The piecemeal dilemma vanishes when negotiators no longer need to negotiate issue-by-issue in order to deal with complexity. A white dot beside any package (beside Sally 1 in FIG. 2 and BigCo 1 in FIG. 26) indicates acceptability to the viewing party. The “?” marks indicate that packages cannot yet be rated because Sally has not specified relative issue importance. Importance of an issue is a measure of how much satisfaction could be gained or lost on that issue, given best and worst outcomes for that issue and assuming certain outcomes on other issues. Importance ratings are always relative. You could double all the numbers and nothing would change. Sally will next specify relative issue importance.

Given her current tight financial situation, Sally feels that Promotion by itself is only half as important as immediate Compensation. On the other hand, she would be willing to give up a lot to be in control of a larger Project Budget, which she considers twice as important as Compensation. Along these lines, as shown in FIG. 3, relative to Compensation being worth an arbitrary 100 points, Sally assigns 50 points to Promotion and 200 points to Project Budget (BigCo relative importance shown in FIG. 27).

After issues have been assigned a relative importance, each package will have a rating between some low value (typically zero) associated with the least preferred package, and a high value (in this case, the total importance contributed by all issues) associated with a most preferred package. If you add together the number of points assigned to each issue (100+50+200), the total is 350, which becomes the rating of the most preferred package. In this way, the rating of any package, that can be displayed within the defined ranges, will fall between 0 and 350.

Scenario IA (Continued from Start)

FIG. 4 (FIG. 28 from BigCo viewpoint) shows how the screen looks after each party has made several concessions. They are closer on Compensation and Project Budget but neither party has budged yet on the Promotion issue.

In the concessions that follow, Sally agrees with BigCo on Project Budget and then BigCo makes a proposal that agrees with Sally on Compensation but not on Promotion. Shown in FIG. 5 (FIG. 29 from BigCo viewpoint) are the last two proposals, with BigCo's last proposal displayed on top.

In FIG. 6, Sally is shown accepting BigCo's last proposal.

When Sally accepts BigCo's last proposal (BigCo 5), the white dot changes to green (indicating that both parties have accepted). BigCo 5 moves to a new group named Tentative as shown in FIG. 7 (FIG. 30 from BigCo viewpoint) and this scenario comes to a happy ending.

The above has illustrated a simple way to use SmartSettle. Guided by ratings derived from minimal preference information, parties made a series of visible concessions and reached an outcome that they were both satisfied with. However, as you will see in the Scenario IB, it turns out that these negotiators have actually left significant value on the table.

Scenario IB (Continued from Scenario IA)

Scenario IB continues where Scenario IA leaves off. Sally and BigCo now wish to improve their existing Tentative solution. They could simply ask SmartSettle to generate an Improvement now. However, encouraged by their facilitator(s), parties first spend some time fine-tuning their preferences.

Sally first considers each issue individually. Shown in FIG. 8 is the Satisfaction Graph for the Promotion issue. Sally has adjusted the height of the bars to show how much relative satisfaction would be gained by each option. This graph shows that, compared to Position B, Position A, set at 30%, is not much better than no promotion at all.

Sally next considers the Project Budget issue. After some discussion with her facilitator, it becomes clear that a given increase in Project Budget would provide more satisfaction at lower values than at higher values. They create a satisfaction function shape such as that shown in FIG. 9 to represent how Sally becomes satisfied on this issue. To exactly recreate the results of this illustration yourself, plot three points for (Satisfaction, Project Budget) at (32, 52), (58, 66) & (82, 83).

BigCo does change SmartSettle's linear defaults for any the satisfaction graphs in this example.

Sally now reconsiders the relative importance between issues. Even though the concepts of importance and ratings may seem to be straightforward, many people are surprised to find that an even swaps exercise, as described below, is very helpful in fine-tuning their preferences.

In FIG. 10, two packages are displayed. The package named Reference (with values 7000, Position A and 70) happens to be the same as the current Tentative agreement. To minimize the effects of possible interdependencies, it is recommended to define tradeoffs around a prediction of final outcome values. The package named Swap 1 (with values 9000, none and 70) is different, but Sally considers it equally satisfactory to the Reference package. To define this equivalent package, Sally has identified an even swap between Compensation and Promotion. Compensation at $9000 and a Promotion at none would be equally satisfactory to Compensation at $7000 and Promotion at Position A. In other words Sally considers $2000 of Compensation an even swap for Position A. The package ratings, however, do not reflect this fact, which confirms the need for this analysis.

Sally has also identified an even swap (Swap 2 in FIG. 11) between Compensation and Project Budget. Compensation of $3000 and a Project Budget of $80,000 would be equally satisfactory to a Compensation of $7000 and a Project Budget of $70,000. In others words, Sally considers $4000 of Compensation an even swap for $10,000 of Project Budget.

Having indicated which packages to include in preference analysis, Sally now chooses to Analyze Included Packages. FIG. 12 shows her choosing this menu item from the Preferences menu.

For the sake of illustration this illustration assumes that BigCo happens to fine-tune SmartSettle's representation of their preferences at the same time as Sally does. BigCo's even swaps are illustrated in FIG. 31 and FIG. 32.

Keeping the relative importance for Compensation constant at 100, SmartSettle adjusts the relative importance for the other two issues in such a way that all three packages have identical ratings as shown in FIG. 13 (FIG. 33 from BigCo viewpoint).

All packages now take on slightly different ratings that more precisely reflect the true preferences of each party (FIG. 14 in Sally's view, FIG. 34 in BigCo's view). In particular, given the satisfaction units fixed relative to the Compensation range being worth 100 points, you can see, if you refer back to Scenario IA, that BigCo 5 is actually worth more than originally estimated.

With preferences now well represented, SmartSettle is able to generate a package named Improvement 1, which produces more satisfaction for both parties and becomes the final solution. Notice in FIG. 15 that Improvement 1 (rated at 320) is worth significantly more to Sally than BigCo 5 (now rated at 270). In BigCo's viewpoint you will see that Improvement 1 is also much better for them (FIG. 35).

Middle of Scenarios II & III (Continued from Start)

This scenario starts with parties making the same first optimistic proposals as in Scenario I. It then shows how parties can use the SmartSettle Suggestion method (multi-issue blind bidding), which lets them skip the concession phase and go straight to a tentative solution. Either party, at any time, can request any number of Suggestions to be generated by SmartSettle between the last proposals made by each party. Parties can choose to accept any of these packages in confidence. In this way, parties can indicate how much they are willing to concede, without revealing that to the other party. If they both accept the same package, it becomes a tentative deal from which they can continue to look for improvements if they wish.

Five Suggestions, named Suggestion 1 through Suggestion 5, are generated. As shown in FIG. 16, the first one, Suggestion 1, rated at 175, is midway between the proposals made by each party.

In FIG. 36, BigCo is about to accept Suggestion 3. In FIG. 37, BigCo has accepted Suggestion 1, Suggestion 3 and Suggestion 5.

In FIG. 17, all five Suggestions are being displayed at the same time. Suggestion 2 and Suggestion 4 have already been accepted by Sally, as indicated by a white dot beside each of those packages. Sally is about to also accept Suggestion 5.

Neither party knows which Suggestions have been accepted by the other party.

Scenario II (Continued from Middle)

When Sally accepts Suggestion 5, it moves to a new group named Tentative, as shown in FIG. 18 (FIG. 38 from BigCo view), and the white dot changes to green. This means that BigCo had also accepted this package and they have a Tentative agreement.

Parties now ask for an Improvement to be generated. As shown in FIG. 19, Improvement 6 (rated at 242) is better for Sally than Suggestion 5 (rated at 220), which was the previous Tentative. Although parties already had a tentative solution, they both preferred and accepted the Improvement, which became the new agreement (FIG. 39 shows this results in BigCo's view).

In this scenario, relatively cooperative parties reached a good agreement quite quickly, even without advanced preference analysis. Since the process so far has been extremely easy. Sally and BigCo still have plenty of energy left. Therefore, let's have them continue on and see what they're still missing. FIG. 20 (FIG. 40 in BigCo view) shows how relative importances and ratings are adjusted after fine-tuning preferences (with the method shown in Scenario IB). We now see that for Sally, given that the Compensation range is fixed at 100 relative satisfaction points, Improvement 6 (now rated at 325) is actually worth more than originally estimated. Suggestion 5 (now rated 306) is also worth more but is still inferior to Improvement 6.

However, when SmartSettle generates Improvement 7 (shown rated at 350 for Sally in FIG. 21 and at 100 for BigCo in FIG. 41), the parties are pleasantly surprised to find that SmartSettle has discovered more value for each of them.

Scenario III, which follows, illustrates what SmartSettle can do to help in more difficult circumstances.

Scenario III (Continued from Middle)

This scenario starts off the same way as Scenario II. However, in this case, BigCo does not accept Suggestion 5. Instead of an easy agreement, it seems that parties are stuck. In situations like this, if parties are not too far apart, SmartSettle can solve the apparent impasse. It does this by finding a single package that is equivalent in terms of satisfaction to each party's least preferred accepted package, which in this case, for Sally, is Suggestion 5. If you have already reviewed this simulation from BigCo's point of view, you will know that BigCo's least preferred accepted package is Suggestion 1. The resulting impasse is displayed in FIG. 22 (FIG. 42 in BigCo view). Of course neither party knows this.

To solve the impasse, SmartSettle generates another package, named Equivalent 6. Since this package simultaneously satisfies both parties, it becomes a Tentative agreement. In Sally's view, as shown in FIG. 23, Equivalent 6 has the same rating as Suggestion 5 even though it has different issue values. In BigCo's view, shown in FIG. 43, Equivalent 6 has the same rating as Suggestion 1.

If you've read the other scenarios, you've seen that it can be quite beneficial to fine-tune preferences prior to generating improvements. FIG. 24 shows how Sally's screen appears after preference analysis (as in Scenario IB). Relative importances have been adjusted relative to Compensation fixed at 100 points. After package ratings are also revised, both Equivalent 6 and Suggestion 5 are worth more, but Equivalent 6 is actually worth a bit less to Sally than Suggestion 5 (although evidently not enough to prevent it from having been accepted earlier).

An impasse is often described as a win-lose situation when neither party is willing to give in (or even lose-lose if they decide to go to court instead). In this scenario, SmartSettle has already found a solution that satisfies both parties, definitely win-win. To take you “beyond win-win” SmartSettle goes one more step and generates Improvement 7. Improvement 7 has a higher rating for both parties than Equivalent 6. Since both parties consider this new package better, it replaces Equivalent 6 and becomes the final outcome (FIG. 25 and FIG. 40).

We claim:

1. A computer-based method for assisting at least two parties involved in a negotiation problem with any number of issues toward achieving a mutually satisfactory agreement on decisions to be taken on one or more of said issues comprising the steps of:
a) providing at least one programmed computer system and an associated interactive graphical interface for interactive input and output of information to and from said computer system, said computer system being programmed to
generate at least one potential agreement on decisions to be taken on one or more of said issues of said negotiation problem in response to entered preference data from each of said parties;
keep confidential any private information and display that information only to the party to whom that information belongs; and
display information that is not private, including mutually acceptable potential agreements, to all parties with permission to see that information.
b) entering into said computer system through said graphical interface, information pertaining to each said party's preferences on the outcome of each of said issues involved in said negotiation problem;
c) entering into said computer system for each of said parties confidential acceptance of one or more potential agreements created by any party or the computer system; and
d) in response to said entering of said information, said programmed computer system
using each party's inputted information to evaluate potential agreements in terms of a specified level of satisfaction according to each party's own preferences;
using said information to generate one or more potential agreements; and
declaring as a tentative agreement among two or more parties, any potential agreement that has been accepted by those parties.

2. The computer-based method of claim 1, further including the steps of
a) entering into said computer system through said graphical interface, tradeoff preference information determining relative issue importance; and
b) entering into said computer system through said graphical interface, proposals and/or potential agreements (which may be declared private);

3. The computer-based method of claim 2, further including the steps of
a) entering detailed tradeoff and satisfaction function preference information or other information from which that information may be derived and analyzing those preferences to determine said specified satisfaction levels more precisely; and
b) using optimization techniques to generate an improved potential agreement that is Pareto optimal according to said entered preferences and displaying said improved potential agreement on said graphical interface.

4. The computer-based method of claim 3, further including the step of entering into said computer system other information from which said preference information may be derived, in an automated process not requiring a graphical interface.

5. The computer-based method of claim 4, further including the steps of:
a) entering into said computer system changed preference information, including acceptance of potential agreements and/or retraction or previous acceptances and/or a different potential agreement; and,
b) in response to said entering of said changed preference information, said programmed computer system generating one or more new potential agreements.

6. The computer-based method of claim 5, wherein said steps in response to said entering of said information, optionally include said programmed computer system:
a) identifying a plurality of potential agreements, one for each of said parties, each said potential agreement being acceptable to its corresponding party and providing a specified level of satisfaction for that party;
b) if said plurality of potential agreements are not identical to one another, generating a potential agreement that is different from said plurality of potential agreements, using optimization techniques to analyze said preference information and provide a level of satisfaction for each said party that is at least as great as the level of satisfaction provided by each said party's acceptable potential agreement; and,
c) displaying said generated potential agreement on said interactive graphical interface for consideration by parties to accept as a tentative agreement to said negotiation problem.

7. The computer-based method of claim 6, wherein said step of providing at least one computer system and an associated interactive graphical interface further comprises:
a) providing a plurality of independent, separate computer systems and associated interactive graphical interfaces, one each for each of said parties, each said independent, separate computer system being programmed to receive and process information from each party, including that pertaining to each of said party's preferences on the outcome of each said issue involved in said conflict; and,
b) providing a central computer system located at a neutral site and a plurality of communication links connecting each of said independent, separate computer systems to said central computer system, said central computer system being programmed to receive preference information from each of said independent, separate computer systems, generate at least one potential agreement to the negotiation problem in response to entered preference information from each of said independent, separate computer systems, and securely transmit generated information and other information to be communicated between parties;
wherein, the information pertaining to each of said party's preferences remains confidential to each party.

8. The computer-based method of claim 1, further including the step of entering into said computer system other information from which said preference information may be derived, in an automated process not requiring a graphical interface.

9. The computer-based method of claim 1, further including the steps of:
c) entering into said computer system changed preference information, including acceptance of potential agreements and/or retraction or previous acceptances and/or a different potential agreement; and,
d) in response to said entering of said changed preference information, said programmed computer system generating one or more new potential agreements.

10. The computer-based method of claim 1, wherein said steps in response to said entering of said information, optionally include said programmed computer system:
d) identifying a plurality of potential agreements, one for each of said parties, each said potential agreement being acceptable to its corresponding party and providing a specified level of satisfaction for that party;
e) if said plurality of potential agreements are not identical to one another, generating a potential agreement that is different from said plurality of potential agreements, using optimization techniques to analyze said preference information and provide a level of satisfaction for each said party that is at least as great as the level of satisfaction provided by each said party's acceptable potential agreement; and,
f) displaying said generated potential agreement on said interactive graphical interface for consideration by parties to accept as a tentative agreement to said negotiation problem.

11. The computer-based method of claim 1, wherein said step of providing at least one computer system and an associated interactive graphical interface further comprises:
providing a plurality of independent, separate computer systems and associated interactive graphical interfaces, one each for each of said parties, each said independent, separate computer system being programmed to receive and process information from each party, including that pertaining to each of said party's preferences on the outcome of each said issue involved in said conflict; and,
providing a central computer system located at a neutral site and a plurality of communication links connecting each of said independent, separate computer systems to said central computer system, said central computer system being programmed to receive preference information from each of said independent, separate computer systems, generate at least one potential agreement to the negotiation problem in response to entered preference information from each of said independent, separate computer systems, and securely transmit generated information and other information to be communicated between parties;
wherein, the information pertaining to each of said party's preferences remains confidential to each party.

12. A computer-based apparatus for assisting at least two parties involved in a negotiation problem with any number of issues toward achieving a mutually satisfactory agreement on decisions to be taken on one or more of said issues, comprising:
a) a plurality of independent, separate computer systems, one for each of said parties, each said computer system being programmed to receive and process communication between parties and/or other information pertaining to each said party's preferences on the outcome of each issue involved in said negotiation problem, including proposals and confidential acceptance of any potential agreement;
b) a plurality of interactive graphical interfaces connected, one each, to each of said independent and separate computer systems for input and output of information to and from the corresponding one of said computer systems;
c) a central computer system located at a neutral site for
processing preference information received from each of said independent separate computer systems;
generating one or more potential agreements to the negotiation problem in response to the inputted preference information from each of said parties, such that said potential agreements fall between other potential agreements created by the parties or the system;
receiving acceptance from each party on any number of existing potential agreements;
maintaining each said party's preference information confidential from every other one of said parties;
when two or more parties accept the same potential agreement, declaring a tentative agreement among said parties; and
d) communication link means connecting each of said independent, separate computer systems with said central computer system.

13. The computer-based apparatus of claim 12, wherein said central computer system is further programmed for generating a new potential agreement from a plurality of existing potential agreements, one for each of said parties, comprised of potential decisions to be taken on at least one of said issues, each said existing potential agreement being communicated to said central computer system from the corresponding one of said plurality of independent, separate computer systems, each said potential agreement being acceptable to its corresponding party and providing a specified level of satisfaction for that party, said new potential agreement being generated from said plurality of acceptable potential agreements and preference information from each party using optimization techniques so that said generated potential agreement provides a level of satisfaction to each said party that is at least as great as the level of satisfaction provided by each said party's acceptable potential agreement.

14. The computer-based apparatus of claim 13, wherein said central computer system is further programmed for generating an improved potential agreement from said tentative agreement that is Pareto optimal according to said information pertaining to each said party's preferences.

15. The computer-based apparatus of claim 12, wherein said central computer system is further programmed for generating an improved potential agreement from said tentative agreement that is Pareto optimal according to said information pertaining to each said party's preferences.

16. A computer-based method for assisting at least two parties involved in a negotiation problem with any number of issues toward achieving an optimal mutually satisfactory agreement on decisions to be taken on one or more of said issues comprising the steps of:
a) providing a plurality of independent, separate computer systems, one for each of said parties, each said independent, separate computer system being programmed to receive and process information pertaining to each of said party's preferences on the outcome of each said issue involved in said conflict;
b) providing a central computer system located at a neutral site and a plurality of communication links connecting each of said independent, separate computer systems to said central computer system, said central computer system being programmed to receive preference information from each of said independent, separate computer systems and generate at least one potential agreement to the negotiation problem in response to entered preference information from each of said independent, separate computer systems;
c) each party entering into their corresponding one of said independent, separate computer systems,
information to be communicated to other parties; and/or
preference information; including bargaining range information, satisfaction function information for each of said issues, information defining tradeoffs between issues, and any number of potential agreements, which said potential agreements may be private or not and accepted or not; or
any other information from which such said preference information may be derived;
d) transmitting said preference information from each of said independent, separate computer systems to said central computer system;
e) said central computer system processing said transmitted preference information from all parties and generating any number of potential agreements to the said negotiation problem;
f) transmitting any said generated potential agreements and any other said information to be communicated to other parties from the said central computer system to the appropriate said independent, separate computer systems;
g) each party responding to said transmitted information by changing preference information, creating new potential agreements and/or accepting any number of potential agreements transmitted from the said central computer system;
h) transmitting said response from each of said independent, separate computer systems to said central computer system;
i) said central computer system declaring a tentative agreement if two or more parties have accepted the same potential agreement and transmitting that information to the appropriate said independent, separate computer systems; and
j) repeating any of the above steps any number of times.

17. The computer-based method of claim 16, further including the steps of
a) if two or more parties involved in said negotiation problem have both accepted any said potential agreement, then at the option of the parties, causing said central computer system to generate an improved potential agreement that is Pareto optimal according to said entered preference information; and
b) repeating the above step any number of times.
